(19) United States
(12) Patent Application Publication
(10) Pub. No.: US 2007/0079051 A1
(43) Pub. Date: Apr. 5, 2007

(54) Data reading device

(76) Inventors: Naoki Tanaka, Tokyo (JP); Tsutomu Gamou, Kanagawa (JP)

Correspondence Address: KATTEN MUCHIN ROSENMAN LLP, 575 MADISON AVENUE, NEW YORK, NY, 10022-2585, US

(21) Appl. No.: 11/515,394

(22) Filed: Sep. 1, 2006

(30) Foreign Application Priority Data
Sep. 15, 2005 (JP) 2005-268429

(51) Int. Cl. G06F 12/00

(52) U.S. Cl. 711/100

(57) ABSTRACT

To provide a data reading device capable of conducting authentication without the need to ensure a single large area in a memory sufficient to hold the entire data, such as a program, to be authenticated. There is provided a data reading device, comprising a control section for reading data to be read from a recording medium which stores the data to be read, and a memory section for holding the data read by the control section, wherein the control section reads the data to be read which is stored in the memory medium while dividing the data into a plurality of segments based on information concerning sizes of a plurality of memory areas ensured in the memory section, sequentially obtains authentication information concerning the segments read, and conducts authentication relative to the data to be read.

### BACKGROUND OF THE INVENTION

1. Field of the Invention

The present invention relates to a data reading device for reading data from a recording medium or the like to provide the data to be processed.

2. Description of the Related Art

Conventionally, as a device for preventing illegal execution or the like of a program, a device for determining whether or not execution of a program is allowed while referring to a hash value of the program, as disclosed in Japanese Patent Laid-open Publication No. 2004-13608, is available. With this device, the entire program which is instructed to be executed is read from a recording medium and stored in a predetermined single contiguous area in a memory, and the hash value of the program stored in the predetermined single contiguous area is calculated before authentication.

With another type of such a device, a program to be executed is initially encrypted, and thereafter decrypted when the program is executed. Also in this case, the whole of the encrypted program is once read and stored in a predetermined single contiguous area before being processed.

When authentication is carried out in the manner described above, it is necessary to ensure in memory a single contiguous area which is large enough to hold the entire program. However, the more sophisticated the program becomes, the larger the program becomes. This makes it more difficult to ensure a single large area sufficient to hold the entire program.

### SUMMARY OF THE INVENTION

The present invention has been conceived in view of the above described situation, and one of the objects is to provide a data reading device capable of conducting authentication without the need to ensure a single large area in a memory sufficient to hold all of the data, such as a program, to be authenticated.

In order to solve a problem of the above-described related art, according to the present invention, there is provided a data reading device, comprising:

a control section for reading data to be read from a recording medium which stores the data to be read; and a memory section for holding the data read by the control section, wherein the control section reads the data to be read which is stored in the memory medium while dividing the data into a plurality of segments based on information concerning sizes of a plurality of memory areas ensured in the memory section, sequentially obtains authentication information concerning the read segments, and conducts authentication for the data to be read.

### BRIEF DESCRIPTION OF THE DRAWINGS

FIG. 1 is a block diagram showing a structure of an example of a data reading device according to an embodiment of the present invention;

FIG. 2 is a block diagram showing a structure of exemplary content of a control section according to the embodiment of the present invention;

FIG. 3 is a diagram explaining an exemplary format of a reading transfer list according to the embodiment of the present invention;

FIG. 4 is a flowchart of exemplary data transfer processing according to the embodiment of the present invention data;

FIG. 5 is a flowchart of exemplary data transfer processing according to the embodiment of the present invention; and

FIG. 6 is a diagram showing exemplary content of the reading transfer list according to the embodiment of the present invention.

### DESCRIPTION OF THE PREFERRED EMBODIMENT

An embodiment of the present invention will be described with reference to the accompanied drawings.

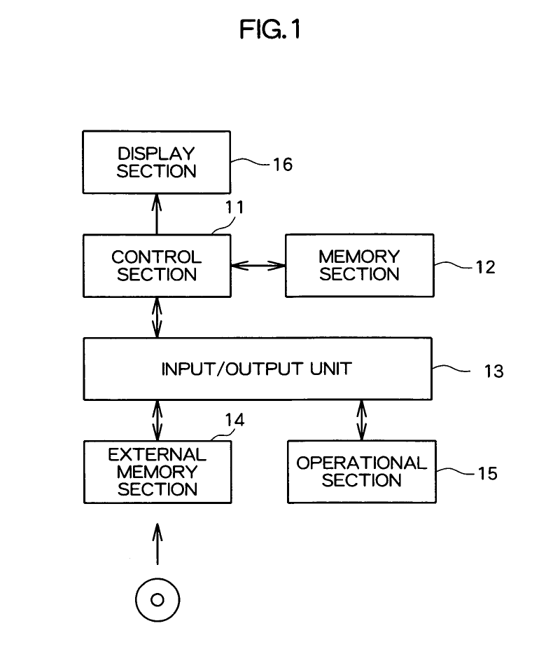

A data reading device in this embodiment may be, for example, a personal computer, a consumer game machine, and so forth, and is constructed comprising, as shown in FIG. 1, a control section 11, a memory section 12, an input/output unit 13, an external memory section 14, an operating section 15, and a display section 16.

The control section 11, which may be a processor chip, for example, stores data in the memory section 12, and executes a program (for example, an application or a game program to be executed by a personal computer) which is read from an external memory medium which is set in the external memory section 14. A specific structure and operation of the control section 11 in this embodiment will be described later in detail.

The memory section 12 is constructed comprising a memory element such as a RAM (Random Access Memory) or the like, and holds a program to be executed by the control section 11. The memory section 12 also functions as a work memory for storing data which is necessary in the processing carried out by the control section 11.

The input/output unit 13 is a bridge chip, and is connected to the control section 11, the external memory section 14, and the operational communication section 15. The input/output unit 13 first selects an output destination to which to send a signal from the control section 11 (an output signal) according to an instruction input from the control section 11, and then selectively outputs the signal from the control section 11 to the selected output destination. In addition, the input/output unit 13 forwards signals which are input from the external memory section 14 and the operational section 15, respectively, to the control section 11.

The external memory section 14 reads information from an external memory medium, such as a Blu-ray Disc, a DVD, and so forth, and outputs the information to the control section 11 via the input/output unit 13. In this embodiment, the external memory medium which is set in the external memory section 14 stores an encrypted program, and also a hash value, which is calculated based on the entire program, as authentication information. The operating section 15, which may be, for example, a controller, a mouse, a keyboard, or the like, all for use with a game, receives an operation carried out by a user, and outputs the content of the operation to the control section 11.

The display section 16, which is a graphics processing board, or the like, draws an image according to an instruction input from the control section 11, and outputs the data on the drawn image to an externally connected display device (a home-use television device, or the like) to be displayed therein.

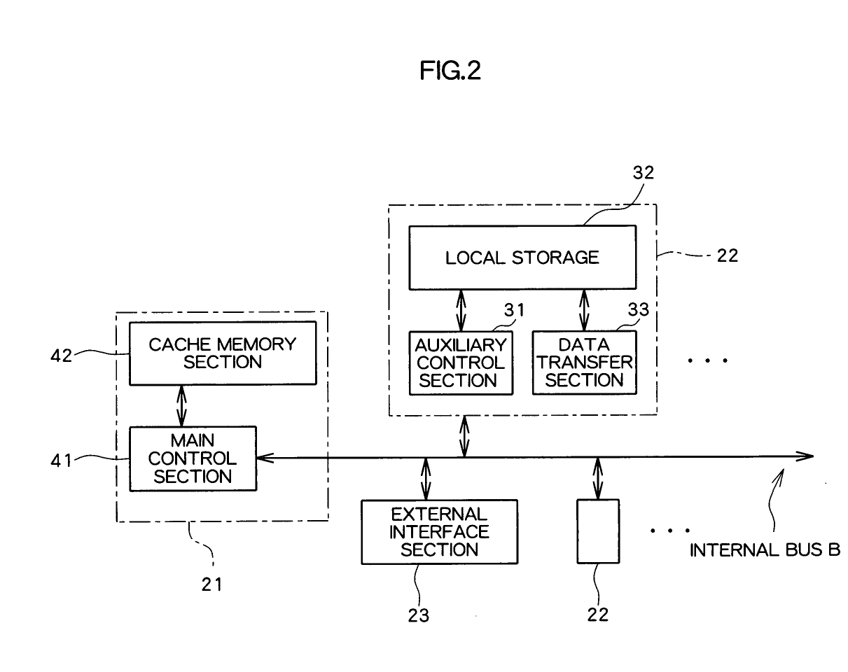

Here, an example of a specific structure of the control section 11 will be described. As shown in FIG. 2, for example, the control section 11 in this embodiment is constructed comprising a plurality of process elements, a main control unit 21, at least one auxiliary control unit 22, and an external interface section 23. The auxiliary control unit 22 comprises an auxiliary control section 31, a local storage section 32 which is provided corresponding to the auxiliary control section 31, and a data transfer section 33. The main control unit 21 comprises a main control section 41 and a cache memory section 42. The main control unit 21 and each of the auxiliary control units 22 are connected to each other via an internal bus B.

The auxiliary control section 31 of the auxiliary control unit 22 is a program control device which operates according to a program obtained via the external interface section 23 or a program stored in the local storage section 32. The auxiliary control section 31 in this embodiment carries out authentication and decryption for a program which is read from the external memory section 14, for example. The authentication and decryption will be described later in detail.

The local storage section 32 is a memory element and holds a program or the like to be executed by the auxiliary control section 31. The local storage section 32 also functions as a work memory of the auxiliary control section 31.

The data transfer section 33 is a DMA (Direct Memory Access) and reads data from a memory area designated in the memory section 12 and stores the data in the local storage section 32. The data transfer section 33 additionally stores the data which is processed by the auxiliary control section 31, in a memory area designated in the memory section 12. An operation of the data transfer section 33 will also be described later in detail.

It should be noted that, although it is described in the above that data is read from the memory section 12, data may alternatively be read from the cache memory section 42. Further, the data transfer section 33 may store the processed data in the cache memory section 42 instead of the memory section 12.

The main control section 41 of the main control unit 21 may be a program control device such as a CPU or the like, and operates in accordance with a program stored in the cache memory 42 or the memory section 12. In reading of data from an external memorymedium in the external memory section 14, the main control section 41 carries out authentication and decryption on the data. The content of the processing to be carried out by the main control section 41 will also be described later in detail.

The cache memory section 42 is a memory element and holds a program to be executed by the main control section 41. The cache memory section 42 also functions as a work memory of the main control section 41. The external interface section 23 exchanges data with respect to external sections including the memory section 12, the input/output unit 13, the external memory section 14, the operating section 15, and the display section 16.

In the following, an operation to be carried out by the data reading device in this embodiment to authenticate data, such as a program, to be executed will be described.

It should be noted that an example is described here in which a program is authenticated. It is assumed that a program to be authenticated is encrypted, and that the main control unit 21 is responsible for reading of an encrypted program and execution of a program restored through decryption, while the auxiliary control unit 22 is responsible for authentication and decryption.

(Data Transfer between Main Control Unit and Auxiliary Control Unit)

In the control section 11, at least a part of the program to be authenticated is transferred from the main control unit 21 to the local storage section 32 in the auxiliary control unit 22. This transfer is effected by the data transfer section 33.

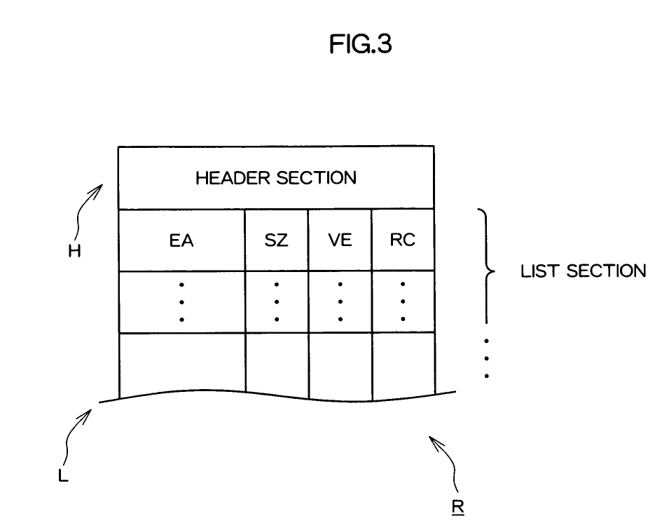

Initially, a specific example of an operation to be carried out by the data transfer section 33 will be described. In the exemplary operation to be described here, the data transfer section 33 carries out data exchange with respect to the memory section 12 while referring as transfer lists to a reading transfer list (R), as shown in FIG. 3, and a writing transfer list (W).

Here, the reading transfer list shown in FIG. 3 has a header section (H) and a list section (L). In the list section (L), at least one entry is listed, which is formed including an effective address (EA), size information (SZ), a validity flag (VE), and a flag indicative of completion of reading (a completion flag RC), all arranged in a mutually associated manner.

The effective address (EA) indicates the value of an address (an address value) in the memory section 12. The validity flag is set at either of two values, one indicative of “valid” meaning that data to be transferred is prepared in the memory section 12 and the other indicative of “invalid” meaning that data to be transferred is yet to be prepared. A completion flag is set at either of two values, one indicative of “uncompleted” meaning that processing is yet to be completed and the other indicative of “completed” meaning that processing is completed. In the initial state, the validity flag is set to “invalid”, while the completion flag is set to “uncompleted”.

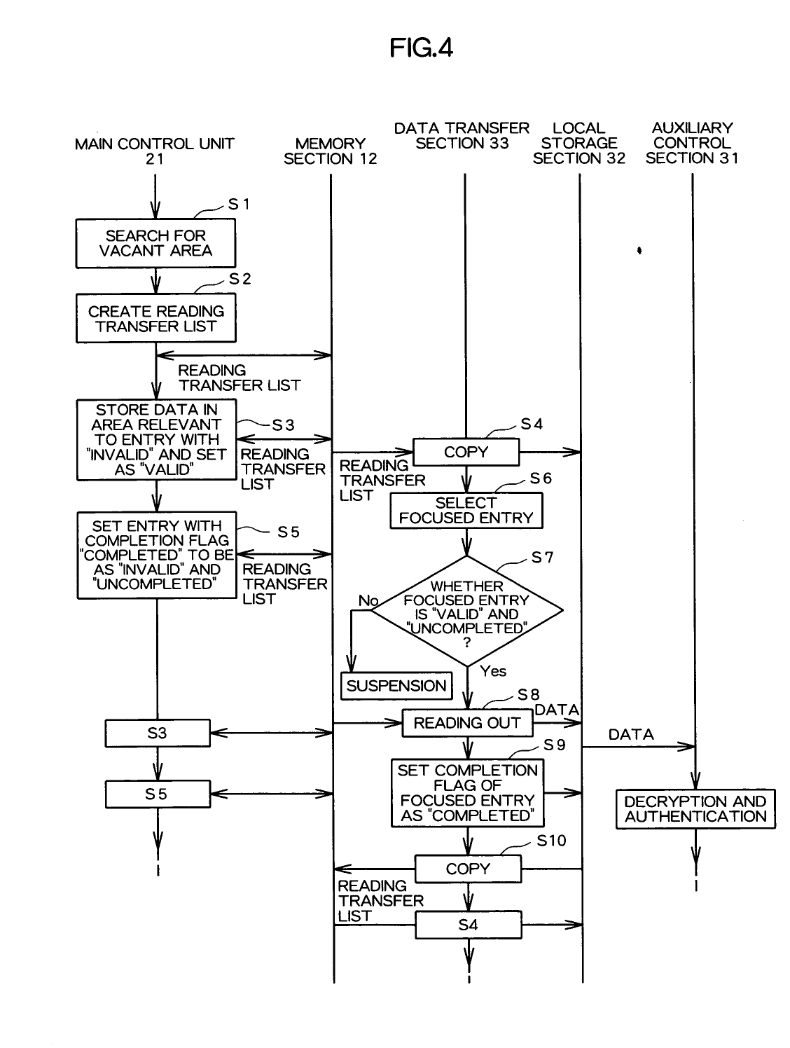

As shown in Fig.4, the main control section 41 searches for a vacant area in the memory section 12 (S1). Then, while using the address value of the vacant area found as a result of the search (that is, an area where significant data is not currently stored) as an effective address, a reading transfer list (R) is created for each auxiliary control unit 22 (that is, for each data transfer section 33), and the created reading transfer list (R) is stored in the memory section 12 (S2). In the above, the validity flag is set to “invalid”, while the completion flag is set to “uncompleted”.

Thereafter, the main control section 41 obtains data, such as a program to be executed or the like, from the external memory section 14 side via the external interface section 23. Then, the main control section 41 divides the data into data segments of sizes corresponding to the sizes of the areas, among the vacant areas found at S1, which are relevant to the entries having validity flags set to “invalid” included in the reading transfer list, and sequentially stores the data segments into the corresponding areas (S3). Subsequently, the validity flag relevant to the entry included in the reading transfer list, which is relevant to an area where data has been completely stored is set to “valid”.

Thereafter, at predetermined copying timing, the data transfer section 33 of the auxiliary control unit 22 reads from the memory section 12 a reading transfer list which is created for that auxiliary control unit 22, and copies the list to the local storage section 32 (S4).

Thereafter, while the auxiliary control unit 22 carries out the processing described below, the main control section 41 looks for an entry having a completion flag set to “completed” in the reading transfer list, and, should such an entry be found, resets the validity flag and completion flag of the entry to “invalid” and “uncompleted”, respectively (S5).

The main control section 41 repetitively carries out the processing from S3 obtaining data such as a program to be executed from the external memory section 14 side via the external interface section 23 and stores the data and thereafter with respect to the area relevant to an entry having a validity flag set to “invalid”, until the ongoing data reading operation is completed, Meanwhile, while referring to the reading transfer list copied to the local storage section 32, the data transfer section 33 of the auxiliary control unit 22 sequentially selects, as focused entries, the entries included in the list, beginning with the top entry and in the order of listing (S6). It is then determined whether or not the validity flag and the completion flag of each of the focused entries are set to “valid” and “uncompleted”, respectively (S7).

When the validity flag is not set to “valid” and the completion flag is not set to “uncompleted”, the ongoing processing is suspended.

On the other hand, when the validity flag is set to “valid” and the completion flag is set to “uncompleted”, data of a size corresponding to the size information relevant to the focused entry is read from the address in the memory section 12, which is identified by the effective address relevant to the focused entry, and stored in the local storage section 32 (S8). At this point, the completion flag of the focused entry is set to “completed” (S9).

Thereafter, the data transfer section 33 updates the content of the reading transfer list held in the local storage section 32, and writes, to thereby store therein, the updated reading transfer list over the memory section 12 (S10). That is, the data transfer section 33 constantly operates so that synchronism in terms of a reading transfer list is maintained between the memory section 12 and the local storage section 32. Subsequently, the data transfer section 33 repeats the processing at S4 and thereafter.

Here, it should be noted that during a period from the moment the auxiliary control unit 22 copies the reading transfer list into a local storage 32 (S4) to the moment the updated reading transfer list held in the local storage 32 is written back into the memory section 12 (S10), the main control units 21 refrains from setting the validity flag or the like of an entry included in the reading transfer list. Specifically, an operation for setting the validity flag or the like is held in a waiting queue, and effected after the processing at S10 is completed.

Alternatively, the auxiliary control unit 22 may refrain from copying at S4 while the main control unit 21 carries out setting of a validity flag or the like.

The auxiliary control section 31 carries out processing including decryption and authentication relative to the data that was read at S8 and stored in the local storage 32.

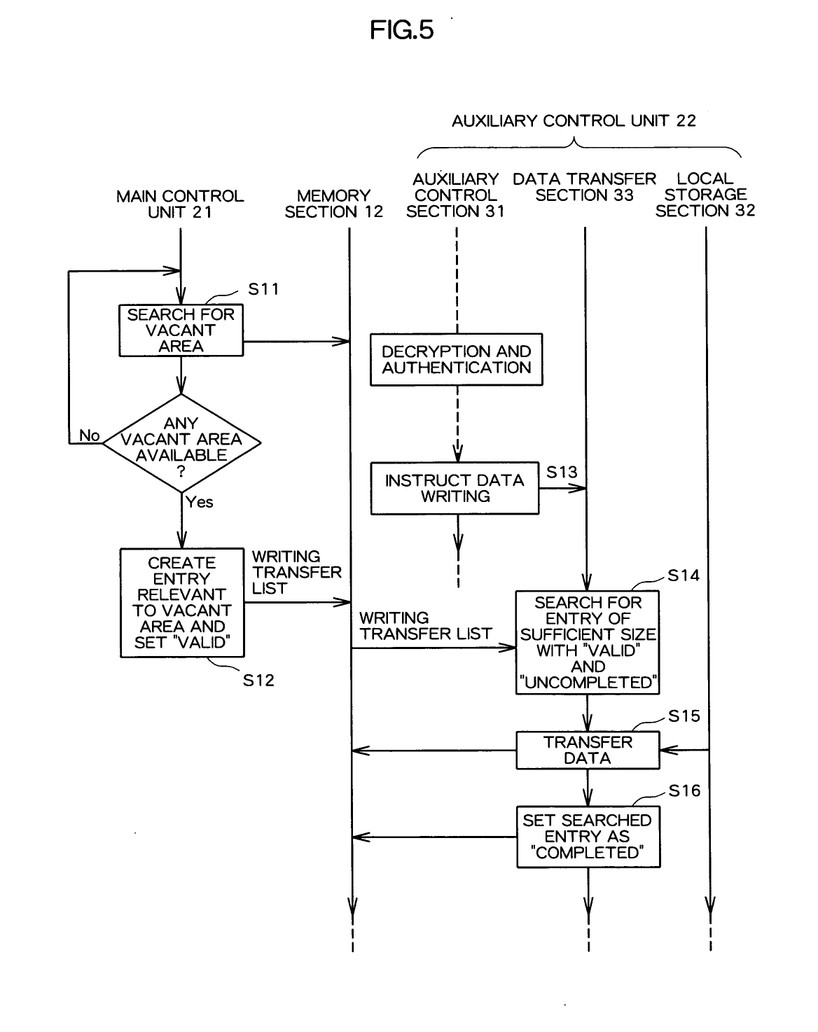

The auxiliary control section 31 and the main control section 41 instruct the data transfer section 33 to transfer the data stored in the local storage section 32 to the memory section 12, as shown in FIG. 5. This instruction is made utilizing a writing transfer list (W). The writing transfer list is created by the main control section 41 so as to have a format in which a header section and a list section (not shown) are included, similar to the reading transfer list shown in FIG. 3.

In the list section, at least one entry is listed, which is formed including an effective address, size information, a validity flag, and a flag indicative of completion of writing (a completion flag), all arranged in a mutually associated manner. The effective address indicates the value of an address (an address value) in the memory section 12. The validity flag is set to either of two values, one indicative of “valid” meaning that a vacant area for holding data is prepared and the other indicative of “invalid” meaning that a vacant area is yet to be prepared. A completion flag is set to either of two values, one indicative of “uncompleted” meaning that processing is yet to be completed and the another indicative of “completed” meaning that processing is completed. In the initial state, the validity flag is set to “invalid”, while the completion flag is set to “uncompleted”.

Specifically, the main control section 41 conducts for a search for a vacant area in the memory section 12 every predetermined timing(S11). When the main control section 41 finds at least one vacant area, an entry having a validity flag set to “invalid” is selected from the entries included in the writing transfer list, and the address and size of the vacant area found are written into the writing transfer list as the effective address and size of the entry selected. Thereafter, the validity flag relevant to that entry is set to “valid” (S12).

Meanwhile, asynchronously with the processing carried out by the main control section 41, the auxiliary control section 31 carries out processing (for example, decryption, authentication, and so forth) relative to the data to be read from the local storage section 32 and written into the memory section 12. When the processing is completed, the auxiliary control section 31 outputs to the data transfer section 33 an instruction requesting data writing, together with the information of the address in the local storage section 32 where the data to be written into the memory section 12 is stored (hereinafter referred to as “an object address”), and the size of the data (hereinafter referred to as “an object size”) (S13).

Upon receipt of the instruction requesting data writing, the data transfer section 33 looks for an entry, while referring to the writing transfer list, which has a validity flag set to “valid”, a completion flag set to “uncompleted”, and size information indicative of a size equal to or larger than the object size (S14) When such an entry is found, a portion of the data of the size corresponding to the object size is read from the object address and transferred to the vacant area in the memory section 12, which begins with the address identified by the effective address of that entry (S15). When this transfer is completed, the data transfer section 33 sets the completion flag of the entry to “completed” (S16).

Meanwhile, when two or more entries each having a validity flag set to “valid”, a completion flag set to “uncompleted”, and size information indicative of a size smaller than the object size are found, the data transfer section 33 may carry out the following processing.

That is, the data transfer section 33 arranges the plurality of entries in sequence such that the entry relevant to the largest size is arranged at the top, followed by the entries relevant to smaller sizes in order. Thereafter, the sizes relevant to the respective entries are summed beginning with the top entry and thereafter sequentially in order. When the sum exceeds the object size during the calculation, the entries included in the size sum (addition) thus far are collectively defined as a focused entry group.

Meanwhile, the data to be written is divided into data segments so as to correspond in terms of size to the respective entries included in the focused entry group. Thereafter, the respective data segments are transferred to the corresponding vacant areas each beginning with the address identified by the effective address relevant to each of the entries included in the focused entry group. Then, the completion flags relevant to the entries included in the focused entry group are set to “completed”.

Alternatively, the entries may be examined beginning with the top of the list to find an entry having a validity flag set to “valid” and a completion flag set to “uncompleted”. Should such an entry be found, a portion of the data to be written, of the size corresponding to the size information relevant to that entry, may be transferred to the vacant area which begins with the address identified by the effective address of that entry.

With the above described arrangement, data to be transferred can be duly transferred while being divided into data segments of the sizes corresponding to the sizes of the vacant areas available.

[Authentication Process]

Next, an operation to be carried out by the data reading device in this embodiment to authenticate a program will be described.

When an external memory medium is set in the external memory section 14 and execution of a program is commanded, the main control section 41 of the main control unit 21 searches for a vacant area available in the memory section 12. It should be noted here that the size of each vacant area may not be large enough to store the whole program. The respective vacant areas need not be contiguous, and may be located separately. The main control section 41 ensures a single area in the memory section 12 to store a program restored through decryption.

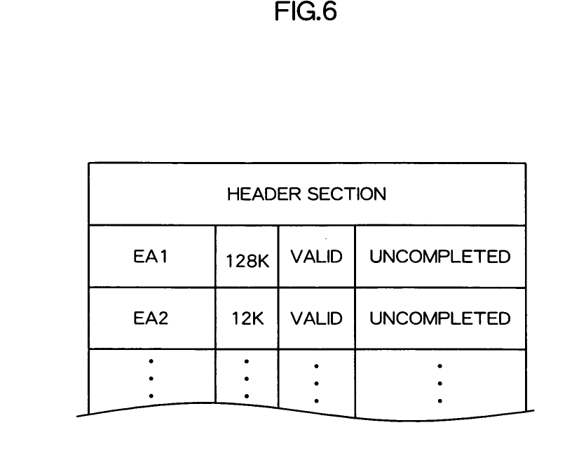

The main control section 41 obtains the effective address pointing to the head of the found vacant area and relevant size information, and creates a reading transfer list. Specifically, supposing that eight vacant areas of 128 kbytes (in the following, abbreviated as 128 k or the like), 12 k, 256 k, 32 k, 4 k, 24 k, 1024 k, and 24 k, are found in the memory section 12. In this case, the main control section 41 creates a reading transfer list such as is shown in FIG. 6. In addition, the main control section 41 reads the program stored in the external memory medium while dividing the program into a plurality of program segments according to the sizes of the vacant areas found, and writes each of the program segments into each of the vacant areas of the corresponding size.

In the above-described example, for example, the main control section 41 reads a portion of the program of the size corresponding to the total size of the respective vacant areas, namely, 1504 k, beginning with the top of the program stored in the external memory medium. Then, the main control section 41 divides the read portion into eight program segments of the sizes 128 k, 12 k, 256 k, 32 k, 4 k, 24 k, 1024 k, and 24 k, respectively, and then stores in the respective vacant areas.

Subsequently, the main control section 41 changes to “valid” the validity flag of the entry among those listed in the reading transfer list, which is relevant to the vacant area with a program segment written therein, whereby the reading transfer list is updated. Then, the main control section 41 notifies the data transfer section 33 of completion of the updating of the reading transfer list. Likewise, the main control section 41 additionally creates a writing transfer list.

Meanwhile, the data transfer section 33 copies the reading transfer list to the local storage section 32 at the copying timing, that is, the timing at which to receive the notice of updating.

Thereafter, the data transfer section 33, while referring to the copied reading transfer list in the local storage section 32, searches for an entry having a validity flag set to “valid” and a completion flag set to “uncompleted”, beginning with the top entry in the list. When such an entry is found, a program segment of the size corresponding to the size information of that entry is read from the address in the memory section 12, which is identified by the effective address of that entry, and stored in the local storage section 32.

Specifically, in the above-described example, a program segment of 128 k is initially transferred to the local storage section 32. Subsequently, program segments corresponding to 12 k, 256 k, 32 k, 4 k, 24 k, 1024 k, and 24 k, respectively, are sequentially transferred to the local storage section 32. The data transfer section 33 changes the completion flags of the entries with data transfer therefrom completed to “completed”.

Having searched through the reading transfer list, that is, up to the last entry, the data transfer section 33 returns to the top entry in the list to continue the search.

The data transfer section 33 again updates the reading transfer list, and overwrites the updated list to the memory section 12.

The main control section 41 refers to the reading transfer list every predetermined timing to check whether or not there is any entry having a completion flag set to “completed”. When any entry having a completion flag set to “completed” is found, a portion of the program stored in the external memory medium, of the size corresponding to the size information relevant to that entry, is read as a program segment. This data reading is carried out while referring to the size information of that entry, and begins with the portion of the program immediately following the portion of the program having been read thus far. The program segment read is stored in the area in the memory section 12 which begins with the address identified by the effective address of that entry. Then, the validity flag of that entry is set to “valid”, while the completion flag thereof is set to “uncompleted”.

Meanwhile, the auxiliary control section 31 reads partial data of the program stored in the local storage section 32, then decrypts the partial data read (a program segment), and stores the result of decryption back in the local storage section 32. Thereafter, the auxiliary control section 31 carries out authentication relative to the program segment. It should be noted that the authentication process here is a process for calculating a hash value as one example of authentication information concerning a program segment to be processed. It should be noted that calculation of a hash value concerning the entire sequential data can be resumed, in the event that the calculation has been suspended in mid course of data processing, from the point of suspension. A hash value which can be obtained through such a calculation is widely known, and therefore not described here in detail.

In the case where the result of previous calculation of a hash value is stored in the local storage section 32, the auxiliary control section 31 calculates a hash value using the calculation result and the object program segment, and stores the result of the calculation in the local storage section 32. On the other hand, when the result of previous calculation of a hash value is not stored in the local storage section 32 (that is, when calculation of a hash value begins), a hash value is calculated using only the object program segment, and the result of the calculation is stored in the local storage section 32.

Further, the auxiliary control section 31 outputs to the data transfer section 33, an instruction requesting data writing, which contains an address at which a program segment restored through decryption is currently stored (an object address) and the size of the program segment (an object size).

Upon receipt of the instruction from the auxiliary control section 31, which requests data writing, the data transfer section 33 searches for an entry, while referring to the writing transfer list, which has a validity flag set to “valid” and a completion flag set to “uncompleted”, beginning with the top entry in the list. When such an entry is found, a portion of the data of the size corresponding to the object size is read from the object address, and transferred to and stored in the vacant area in the memory section 12, which begins with the address identified by the effective address of that entry. Upon completion of the transfer, the data transfer section 33 sets the completion flag of that entry to “completed”.

It should be noted here that the main control section 41 of the main control unit 21 checks the reading transfer list and the writing transfer list every predetermined timing. When any entry having a completion flag set to “completed” is found in the reading transfer list, the effective flag of that entry is set to “invalid”, whereby the area relevant to that entry is defined as a vacant area. With this operation, the area beginning with the address identified by the effective address relevant to the entry having a completion flag set to “completed” is ensured as a vacant area, becoming available for the writing operation.

Further, when any entry having a completion flag set to “completed” is found in the writing transfer list, a portion of data (that is, a program segment restored through decryption) of the size corresponding to the size information relevant to that entry is read from the area in the memory section 12, which begins with the address identified by the effective address of that entry, while referring to the effective address and size information of that entry. Then, the read portion of the data is copied to the area in the memory section 12, which is ensured for program storage. At this point, the completion flag of that entry is reset to “uncompleted”.

Having read out the entire program, that is, up to the end thereof, which is stored in the external memory device, the main control section 41 informs the auxiliary control section 31 of the completion of the processing, and then sets the validity flags of the respective entries included in the reading transfer list to “invalid”.

After receipt of the notice of completion of the processing, the auxiliary control section 31 calculates a hash value for the program segment having been transferred to, and currently stored in, the local storage section 32. Then, after completion of the calculation, the auxiliary control section 31 compares the calculated hash value and the hash value stored in the external memory medium. For the hash values matched, it is determined that the concerned program is authentic, and the result of the determination is notified to the main control section 41.

Currently, the program restored through decryption by the auxiliary control unit 22 is stored in the memory section 12. In the case where it is confirmed that the stored program is authentic by checking the notice from the auxiliary control section 31, the main control section 41 executes the program stored. On the other hand, when authenticity of the stored program is not confirmed, the program may not be executed.

It should be noted that although an example is illustrated in which a single auxiliary control section 31 is employed, a case in which two or more auxiliary control units 22 are provided may also be applicable, as described above. In this case, the main control section 41 creates and updates reading transfer lists and writing transfer lists for the respective auxiliary control units 22, and each of the auxiliary control units 22 obtains a program segment to be authenticated using a corresponding reading transfer list and a corresponding writing transfer list, and applies authentication and decryption relative to the program segment.

With the arrangement as described above in which reading transfer lists and so forth are created corresponding to a plurality of auxiliary control units 22 so that each of the auxiliary control units 22 carries out predetermined processing relative to the program segment/segments allocated thereto, process efficiency is improved.

In this case, the main control section 41 receives the result of authentication (for example, original information for a hash value, that is, partial authentication information) from each of the auxiliary control units 22 which have conducted authentication, then calculates a hash value, and conducts authentication using the calculated hash value.

Also, in this case, each of the reading transfer list and the writing transfer list created for the respective auxiliary control units 22 may include a predetermined number of entries, so that the length of such a list remains fixed.

According to this embodiment, as data such as a program to be authenticated is divided before authentication, authentication relative to that data can be carried out without the need to ensure a single large area sufficient to hold the entire program in a memory.

What is claimed is:

1. A data reading device, comprising:
a control section for reading data to be read from a recording medium which stores the data to be read; and
a memory section for holding the data read by the control section,
wherein
the control section reads the data to be read which is stored in the memory medium while dividing the data into a plurality of segments based on information concerning sizes of a plurality of memory areas ensured in the memory section, sequentially obtains authentication information concerning the segments read, and conducts authentication relative to the data to be read.

2. The data reading device according to claim 1, wherein
the control section comprises a plurality of process elements,
at least some of the plurality of process elements carry out processing relative to the one or more segments allotted thereto to thereby obtain partial authentication information, and
authentication information is obtained using the partial authentication information which is obtained by each of the processing elements, and provided to be used in authentication of the data to be read.

3. The data reading device according to claim 1, wherein
the control section comprises a plurality of process elements, and,
when data is transferred among the plurality of process elements, a process element from which the data is transferred creates a transfer list in which addresses and sizes of the plurality of memory areas ensured in the memory section are recorded, and data to be transferred is divided into a plurality of segments based on the information concerning the sizes of the plurality of memory areas ensured in the memory section, and stored in the plurality of memory areas, and
a process element to which the data is transferred obtains the data divided into segments stored in the plurality of memory areas, while referring to the transfer list created by the process element from which the data is transferred.

4. A method for authentication, using a data reading device, comprising a control section for reading data to be read from a recording medium which stores the data to be read and a memory section for holding the data read by the control section, for causing the control section to read the data to be read which is stored in the memory medium while dividing the data into a plurality of segments based on information concerning sizes of a plurality of memory areas ensured in the memory section, to sequentially obtain authentication information concerning the segments read, and to
conduct authentication relative to the data to be read.
